(19) United States
(12) Patent Application Publication
(10) Pub. No.: US 2006/0221899 A1
(43) Pub. Date: Oct. 5, 2006

(54) Triggers for media independent handover

(76) Inventors: Peretz M. Feder, Englewood, NJ (US); Ajay Rajkumar, Morristown, NJ (US); Sampath Rangarajan, Bridgewater, NJ (US); Yousif M. Targali, Sayreville, NJ (US)

Correspondence Address: HARNESS, DICKEY & PIERCE, P.L.C., P.O. BOX 8910, RESTON, VA, 20195, US

(21) Appl. No.: 11/094,432

(22) Filed: Mar. 31, 2005

(51) Int. Cl. H04Q 7/00

(52) U.S. Cl. 370/331

(57) ABSTRACT

At least one trigger at a point-to-point protocol layer indicating a status of a point-to-point link is generated and sent to a media independent handover entity.

### BACKGROUND OF THE INVENTION

Currently, an IEEE 802.21 working group is developing a standard framework for enabling media independent handover (MIH) between various wireline and wireless access technologies such as 802.3/11/15/16, as well as those standardized by 3GPP (e.g., UMTS, HSDPA) and 3GPP2 (e.g., CDMA200 1x, EVDO).

Media independent handover will be enabled by an MIH entity that resides on the mobile node (MN) or mobile as well as the network (for example, on the base-station). The mobile node is generally assumed to be a multi-mode node with support for more than one interface type between which a handover can take place.

The MIH entity will reside above the MAC layer (802.11 and 802.16) or as part of the MAC layer (3GPP, 3GPP2) at both the mobile node and the network (e.g., a base station. FIG. 1 illustrates an example of a conventional mobile node 3GPP with anticipated 802.21 compliant architecture that includes an MIH entity, and FIG. 2 illustrates an example of a conventional mobile node 3GPP2 with anticipated 802.21 compliant architecture that includes an MIH entity.

The MIH entity will receive “triggers” from the lower layers such as the media access control (MAC) layer and the physical (PHY) layer. The MIH entity may either pass these triggers to upper layers (e.g., the MM/SM layer in FIG. 1) or process these triggers and send “directives” based on these triggers both to the upper and lower layers to enable seamless handover of a data session when the mobile moves from one access technology to another. In addition to receiving triggers and passing directives within the network and mobile node, respectively, the MIH entities on the base station and the mobile node can exchange these directives among themselves. The MIH entity on the network (possibly on the base station) can interface with a policy server, and information received from the policy server could be used by the MIH to determine handover directives (in addition to the use of lower layer triggers). Currently, the types of triggers and triggering events have not been established.

### SUMMARY OF THE INVENTION

According to the present invention, the 3GPP, 3GPP2, etc., architectures are modified to include a link from the point-to-point protocol (PPP) layer to the media independent handover (MIH) entity. For example, the PPP layer includes a service access point (SAP) for communicating with the MIH.

In one embodiment, at least one trigger at the PPP layer indicating a status of a PPP link is generated and sent to the MIH.

In one embodiment, at least one trigger indicating a status of a link control phase of establishing the link may be generated. For example, triggers that may be generated include a trigger to indicate that link control phase configuration failed if a link control phase parameter exchange fails; a trigger to indicate, prior to authentication during the link control phase, that a link is open if a link control phase parameter exchange is successful; a trigger to indicate a link is up if an authentication during the link control phase is successful; and/or a trigger to indicate an authentication during the link control phase has failed if the authentication during the link control phase is unsuccessful.

In another embodiment, a trigger indicating a status of a network control phase of the link may be generated. For example, triggers that may be generated include a link layer trigger to indicate if an Internet Protocol Control Protocol parameter exchange is successful; a link layer trigger to indicate if an Internet Protocol Control Protocol parameter exchange is unsuccessful; a link layer trigger to indicate if an Internet Protocol Control Protocol link is closed; and/or a link layer trigger to indicate if an Internet Protocol Control Protocol link is being closed because of a time out event. In yet another embodiment, the trigger or triggers may be a trigger to indicate if a lower layer link failure has taken place with respect to the link; a trigger to indicate if link quality of the link is below a threshold; a trigger to indicate if the link will be terminated because of a time-out event; a trigger to indicate that a local end-point is closing the link; and/or a trigger to indicate that a remote end-point is closing the link.

### BRIEF DESCRIPTION OF THE DRAWINGS

The present invention will become more fully understood from the detailed description given herein below and the accompanying drawings which are given by way of illustration only, wherein like reference numerals designate corresponding parts in the various drawings, and wherein:

FIG. 1 illustrates an example of a conventional mobile node 3GPP with anticipated 802.21 compliant architecture that includes an MIH entity;

FIG. 2 illustrates an example of a conventional mobile node 3GPP2 with anticipated 802.21 compliant architecture that includes an MIH entity;

FIG. 3 illustrates an example of the mobile node architecture of FIG. 1 that has been modified according to an embodiment of the present invention;

FIG. 4 illustrates an example of the mobile node architecture of FIG. 2 that has been modified according to an embodiment of the present invention; and

FIG. 5 illustrates a state machine according to which the PPP layer of FIG. 3 or FIG. 4 operates according to an embodiment of the present invention to generate link level triggers that may be used by the MIH entity.

### DETAILED DESCRIPTION OF EXAMPLE EMBODIMENTS

The present invention provides a number of triggers that may be sent to the media independent handover (MIH) entity to improve handover speed and performance. First, example 3GPP and 3GPP2 architecture modifications to support these new triggers will be described. Then, an embodiment of a state machine, employed by the point-to-point protocol (PPP) layer, to generate triggers for the MIH entity will be described.

### Example 3GPP and 3GPP2 Architectures

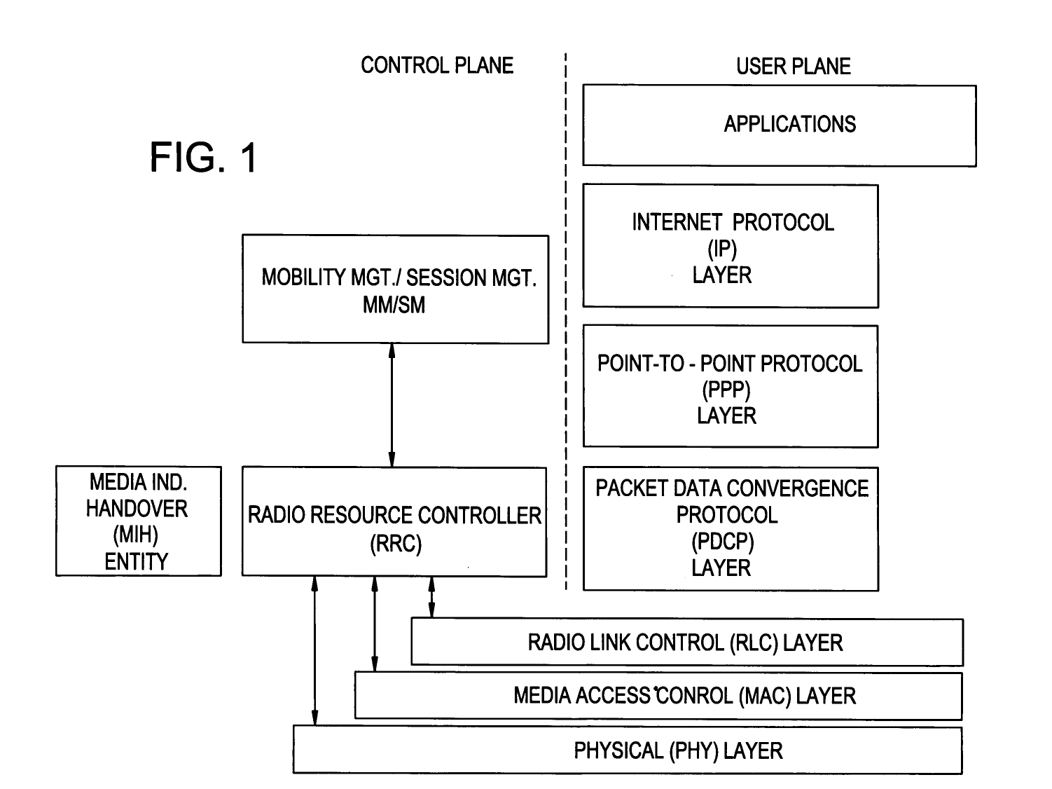

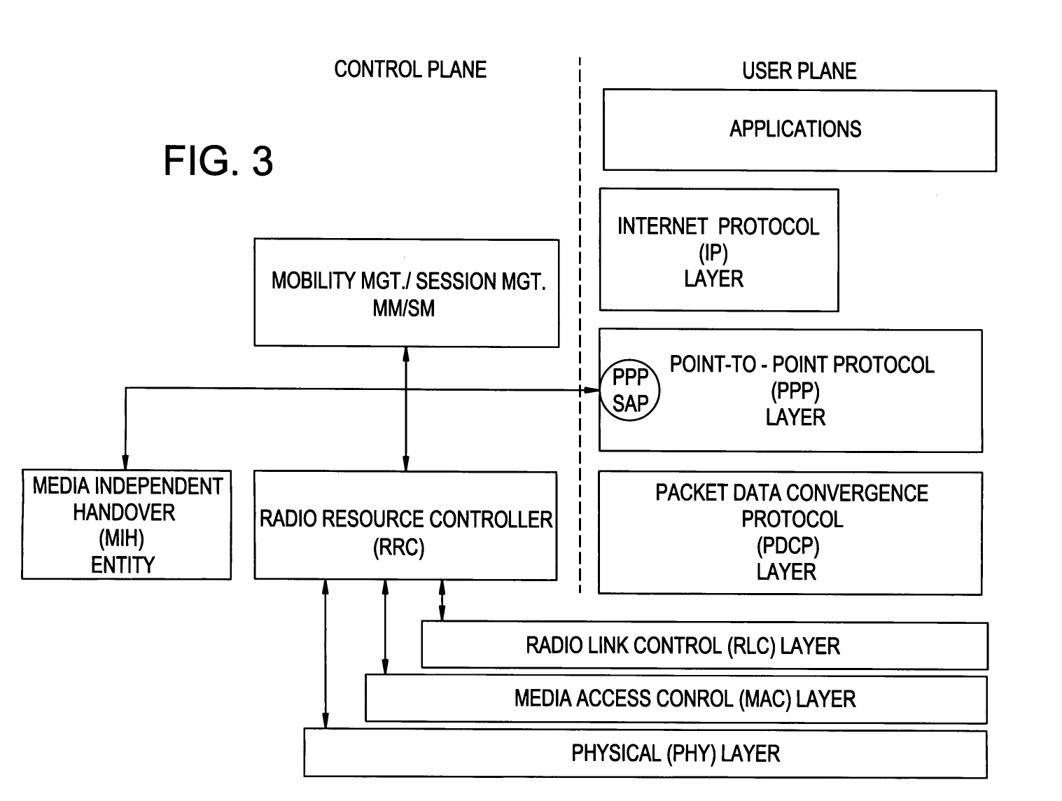

FIG. 3 illustrates an example of the architecture of FIG. 1 that has been modified according to an embodiment of the present invention. As shown, FIG. 3 is the same as FIG. 1, except that the PPP layer includes a service access point (SAP) for communicating with the MIH. Namely, FIG. 3 illustrates a scenario where PPP triggers are sent to the MIH using a PPP SAP (Service Access Point). In this embodiment, triggers may be sent from the PPP layer within a standard 3GPP mobile node (typically referred to as user equipment or UE) to the MIH entity. It will be understood that FIG. 3 is merely an example, and other architectures are possible. For example, the MIH may be incorporated into the 3GPP architecture without necessarily being 802.21 compliant.

Also, while FIG. 3 illustrates the mobile node side, this architecture may also be used at the network side. For example, the PPP layer may reside at the gateway GPRS support node (GGSN), and the MIH entity within the 3G network may be distributed across the various components of the 3G network such as the Node_B, the RNC (radio network controller) and the GGSN.

Within the UE, PPP triggers may be sent to the MIH entity within the UE. At, the other PPP end-point, given that the GGSN terminates PPP sessions, PPP triggers are expected to be sent to the MIH component that resides on the GGSN.

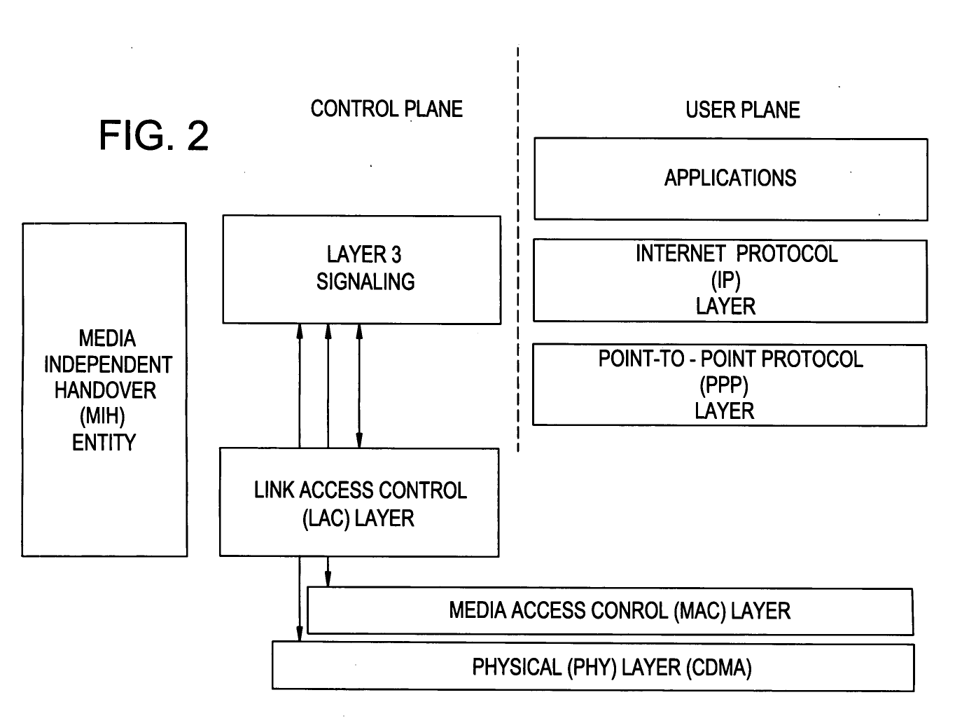

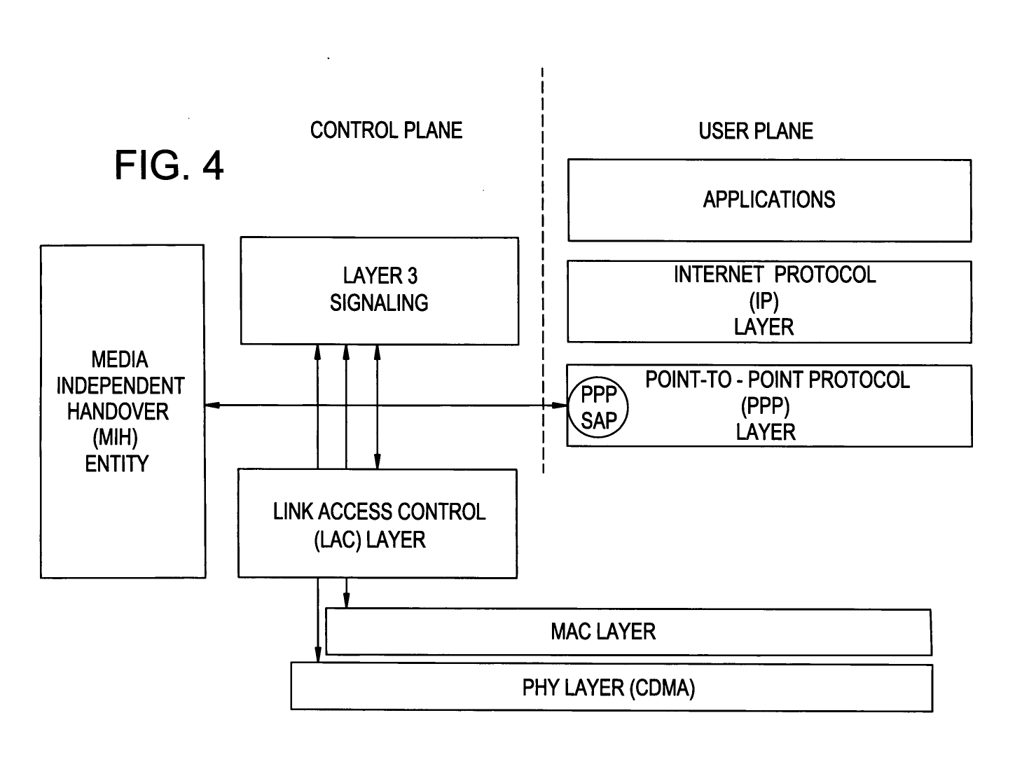

FIG. 4 illustrates an example of the 3GPP2 architecture of FIG. 2 modified according to an embodiment of the present invention. As shown, FIG. 4 is the same as FIG. 2, except that the PPP layer includes a SAP for communicating with the MIH. Namely, FIG. 4 illustrates a scenario where PPP triggers are sent to the MIH using a PPP SAP (Service Access Point). In this embodiment, triggers may be sent from the PPP layer within a standard 3GPP2 mobile node (typically referred to as user equipment or mobile station, mobile terminal, etc.) to the MIH entity. It will be understood that FIG. 4 is merely an example, and other architectures are possible. For example, the MIH may be incorporated into the 3GPP2 architecture without necessarily being 802.21 compliant.

Also, while FIG. 4 illustrates the mobile node side, this architecture may also be used at the network side. For example, the PPP layer may reside at the packet data serving node (PDSN), and the MIH entity within the 3GPP2 network may be distributed across the various components of the network such as the base transceiver station BTS, the base station controller BSC and the PDSN.

Within the mobile node, PPP triggers may be sent to the MIH entity within the mobile node. At the other PPP end-point, given that the PDSN terminates PPP sessions, PPP triggers are expected to be sent to the MIH component that resides in the network for example on the PDSN.

PPP Layer

Before describing the state machine employed by the PPP layer according to the present invention, a general description of the well-known functions performed by the PPP layer in 3GPP and 3GPP2 will be described.

PPP Layer in 3GPP

In a UMTS network standardized by 3GPP, a mobile user may establish a packet connection with packet data networks using a Packet Data Protocol (PDP). The two types for PDP are: PPP and IP (internet protocol). The PDP type of PPP consists of a PPP protocol stack above a packet data convergence protocol (PDCP) layer in the UE and above GTP in the GGSN. The GGSN may either terminate the PPP protocol or further tunnel PPP PDUs (packet data units) via, for example, a layer 2 transport (L2TP). The discussion here assumes the GGSN terminates the PPP protocol. The PPP provides a mechanism to establish a point-to-point link between the UE and the GGSN and then encapsulate and transport IP packets over this link. The PPP link establishment goes through two phases.

In the first phase, called the Link Control Phase, the establishment of the point-to-point link is negotiated through a sub-protocol called the Link Control Protocol (LCP) where LCP packets are used to exchange link specific parameters between the UE and the GGSN to configure, test and later terminate the data link. During this phase, the user is authenticated using an authentication protocol such as CHAP (Challenge Handshake Authentication Protocol) or PAP (Password Authentication Protocol) or no authentication. CHAP is a three-way handshake protocol where the authenticator (e.g., the GGSN) sends a “challenge” to the UE, which then computes a “response” based on a one-way hash function (which is the secret key) and then returns the response to the GGSN. PAP is a clear-text authentication protocol based on username and password.

In the second phase, called the Network Control Phase, a sub-protocol called the Internet Protocol Control Protocol (IPCP) is used to manage the specific needs of the IP packets that are transported over the PPP link. IPCP allows the GGSN to assign an IP address and DNS server IP address to the UE (in case of Simple-IP) and negotiate the, IP header compression algorithm to use on IP packets transported over the PPP link. The header compression algorithms normally used are VJ (Van Jacobson) compression for TCP/IP headers and ROHC (Robust Header Compression) for IP/UDP/RTP. In addition, the Network Control Phase consists of another sub-protocol called the CCP (Compression Control Protocol) that is responsible for configuring, enabling, and disabling data compression algorithms on both ends of a PPP link. The compression algorithm is negotiated for each direction. Once these two phases are complete, IP packets are encapsulated and transported over the PPP link. Thus, the four sub-protocols LCP, CHAP/PAP, IPCP and CCP, in that order, make up the different steps in the configuration of a PPP session.

PPP Layer in 3GPP2

Within a CDMA2000 network standardized by 3GPP2, PPP provides a mechanism to establish a point-to-point link between the mobile node and the PDSN and then encapsulate and transport IP packets over this link. The PPP link establishment goes through two phases.

In the first phase, called the Link Control Phase, the establishment of the point-to-point link is negotiated through a sub-protocol called the Link Control Protocol (LCP) where LCP packets are used to exchange link specific parameters between the mobile node and the PDSN to configure, test and later terminate the data link. During this phase, the user is authenticated using an authentication protocol such as CHAP (Challenge Handshake Authentication Protocol) or PAP (Password Authentication Protocol). CHAP is a three-way handshake protocol where the authenticator (e.g., the PDSN) sends a “challenge” to the mobile node, which then computes a “response” based on a one-way hash function (which is the secret key) and then returns the response to the PDSN. PAP is a clear-text authentication protocol based on username and password.

In the second phase, called the Network Control Phase, a sub-protocol called the Internet Protocol Control Protocol (IPCP) is used to manage the specific needs of the IP packets that are transported over the PPP link. IPCP allows the PDSN to assign an IP address and DNS server IP address to the mobile node (in case of Simple-IP) and negotiate the IP header compression algorithm to use on IP packets transported over the PPP link. The header compression algorithms normally used are VJ (Van Jacobson) compression for TCP/IP headers and ROHC (Robust Header Compression) for IP/UDP/RTP. In addition, the Network Control Phase consists of another sub-protocol called the CCP (Compression Control Protocol) that is responsible for configuring, enabling, and disabling data compression algorithms on both ends of a PPP link. The compression algorithm is negotiated for each direction. The algorithms used in CDMA2000 standard are MPPC LZS and Deflate. Once these two phases are complete, IP packets are encapsulated and transported over the PPP link. Thus, the four sub-protocols LCP, CHAP/PAP, IPCP and CCP, in that order, make up the different steps in the configuration of a PPP session.

PPP State Machine

As will be appreciated from the above description, the PPP implementation in 3GPP and 3GPP2 are substantially the same. As such, the same mechanism for generating PPP triggers to be sent to the MIH entity may be used in either a 3GPP or 3GPP2 architecture. As described in detail below, PPP triggers are generated, according to a state machine embodiment of the present invention, from the PPP layer and sent to the MIH entity during both phases of PPP link establishment. These triggers may also be run on an 802.11, 802.16, etc. network if they use PPP links so that they could be used by the MIH entity both on the MN/UE and the Access Point (in the case of 802.11), WiMax base station (in the case of 802.16) or any other network element on these networks. . Of the four sub-protocols, triggers generated during LCP, CHAP/PAP and IPCP could potentially be used by the MIH functionality to generate events (e.g., MIH_LCP_LINK_UP. Indication for PPP link coming up or MIH_IPCP_LINK_CLOSED. Indication for PPP down indication) to be passed to the upper and lower layers.

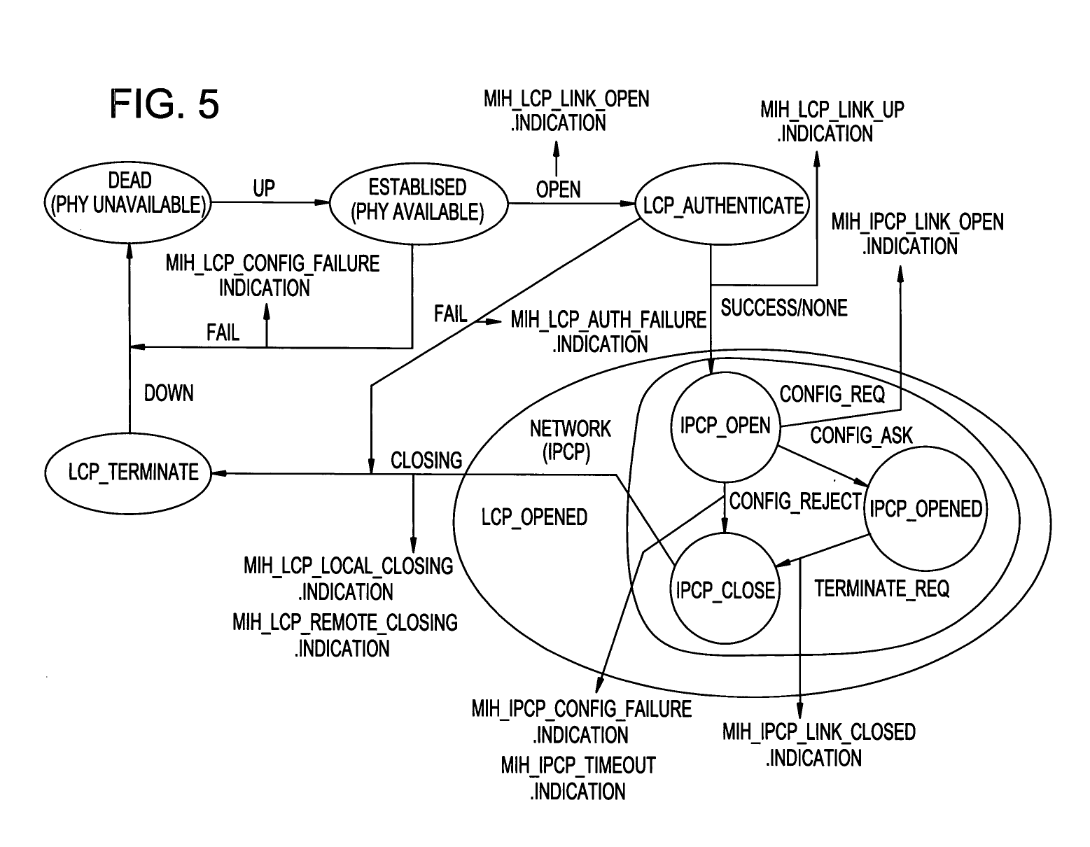

FIG. 5 illustrates a state machine according to which the PPP layer of FIG. 3 or FIG. 4 operates according to an embodiment of the present invention to generate triggers for the MIH entity. In describing the state machine, first the PPP triggers generated during the Link Control Phase will be described and then the triggers generated during the Network Control Phase will be described. Note that the Network Control Phase is a component within the PPP state machine and takes place when the Link Control Protocol has opened the PPP link. The Link Control Phase continues until the link is terminated. PPP Triggers during Link Control Phase

As shown in the state machine sequence for PPP link negotiation, maintenance and termination, when a PPP link is to be established, the availability of the physical layer is checked and if it is available it is deemed that PPP negotiation may be initiated. This is indicated by the Established state. From this state, the end-points exchange LCP parameters to open the LCP link. If this parameter exchange fails due to some reason, an indicator that the LCP configuration failed MIH_LCP_CONFIG_FAILURE.indication is triggered and sent to the MIH entity, and the PPP link establishment fails. The state machine then returns to the Dead state where the physical layer is unavailable.

If, in the Established state, the LCP parameter exchange is successful, the end-points move into the LCP_Authenticate state. During this transition a MIH_LCP_LINK_OPEN.indication trigger is sent to the MIH entity, which indicates that the link is open but authentication (that is CHAP/PAP) has yet to be performed. Once the authentication is successful, the state machine moves into the LCP Opened state. The successful authentication triggers a MIH_LCP_LINK_UP.indication, which indicates that the LCP link is up—namely that the link is open and authentication was successful.

If in the LCP_Authentication state, the authentication is unsuccessful, a MIH_LCP_AUTH_FAILURE.indication trigger is sent to the MIH entity, and the link is terminated by moving the state machine to the LCP_Terminate state. When closing the PPP link, the closing or termination may be initiated by the local end-point or the remote-end point, In either case, when appropriate messages are received, the state machine moves to the LCP_Terminate state. Depending on which end-point initiated the closing of the PPP link, appropriate triggers MIH_LCP_LOCAL_CLOSING.indication and MIH_LCP_REMOTE_CLOSING.indication are sent to the MIH entity. The MIH_LCP_LOCAL_CLOSING.indication indicates that the end-point running the state machine closed the LCP link, and the MIH_LCP_REMOTE_CLOSING.indication indicates that the other end-point closed the LCP link. The state machine then moves from the LCP_Terminate state to the Dead state.

In addition, three triggers that are not dependent on state transitions but could happen any time when the state machine is either in the Established, LCP Authenticate or LCP Opened states are:
MIH_LCP_CARRIER_FAILURE.indication, which indicates a lower layer link failure has taken place and hence the PPP link will be terminated;
MIH_LCP_LINK_QUALTIY_FAILURE.indication, which indicates that the link quality is below a configured threshold (this does not necessarily mean that PPP link should be terminated); and
MIH_LCP_TIMEOUT_FAILURE.indication, which indicates that the PPP link will be terminated because of some time-out (possibly because an expected message does not arrive before the expiration of a timer).
   PPP Triggers During Network Control Phase

Within the LCP_Opened state, during the Network Control Phase, the sub-protocol of interest is the IPCP. The (sub) state machine for IPCP is shown within the LCP Opened state in FIG. 5. From the IPCP Open state, if the IPCP parameter configuration is successful, the state machine moves to the IPCP_Opened state and the trigger MIH_IPCP_LINK_OPEN.indication is generated and sent to the MIH entity. The MIH_IPCP_LINK_OPEN.indication trigger indicates that the IPCP link is open. If the parameter configuration is unsuccessful, the state machine moves to the IPCP_Close state and the trigger MIH_IPCP_CONFIG_FAILURE.indication is generated and sent to the MIH entity. The MIH_IPCP_CONFIG_FAILURE.indication trigger indicates that the IPCP configuration failed. If the IPCP link is closed normally, the state machine moves from the IPCP_Opened state to the IPCP_Closed state and the trigger MIH_IPCP_LINK_CLOSED.indication, indicating normal closure of the IPCP link, is generated and sent to the MIH entity. In addition, when IPCP parameters are being exchanged, if there is a time-out event (e.g., a timer expires before an expected message is received), a MIH_IPCP_TIMEOUT.indication, indicating this situation, is generated and sent to the MIH entity. In this situation, the state machine moves to the IPCP_Closed state.

When the IPCP link closes, the state machine then moves from the LCP Opened state to the LCP_Terminate state, and the appropriate one of the MIH_LCP_LOCAL_CLOSING.indication and MIH_LCP_REMOTE_CLOSING.indication are sent to the MIH entity as described in detail above.

### CONCLUSION

The PPP triggers generated according to the present invention provide the MIH entity with link layer information that may be used to more efficiently provide media independent handover. For example, when handing over from a first technology to a second, different technology, the MIH_LCP_LINK_OPEN.indication will notify the MIH entity that the new link has been established and will be up once authentication takes place. The MIH entity may react to this triggers by sending appropriate handover preparation messages to the upper and lower layers. Once the MIH_LCP_LINK_UP.indication is received, the MIH entity may initiate handover or send instructions to effect handover. Alternatively, the MIHLCP_AUTH_FAILURE.indication trigger may be used by the MIH entity to prevent handover to a link that can not be authorized by the authenticator. This could prevent call drop events.

The invention being thus described, it will be obvious that the same may be varied in many ways. Such variations are not to be regarded as a departure from the invention, and all such modifications are intended to be included within the scope of the invention.

We claim:

1. A method, comprising:
generating at least one trigger at a point-to-point protocol layer indicating a status of a point-to-point link; and
sending the trigger to a media independent handover entity.

2. The method of claim 1, wherein the generating step generates at least one trigger indicating a status of a link control phase of establishing the link.

3. The method of claim 2, wherein the generating step generates a trigger to indicate that link control phase configuration failed if a link control phase parameter exchange fails.

4. The method of claim 2, wherein the generating step generates a trigger to indicate, prior to authentication during the link control phase, that a link is open if a link control phase parameter exchange is successful.

5. The method of claim 2, wherein the generating step generates a trigger to indicate a link is up if an authentication during the link control phase is successful.

6. The method of claim 2, wherein the generating step generates a trigger to indicate an authentication during the link control phase has failed if the authentication during the link control phase is unsuccessful.

7. The method of claim 1, wherein the generating step generates a trigger indicating a status of a network control phase of the link.

8. The method of claim 7, wherein the generating step generates a trigger to indicate if an Internet Protocol Control Protocol parameter exchange is successful.

9. The method of claim 7, wherein the generating step generates a link layer trigger to indicate if an Internet Protocol Control Protocol parameter exchange is unsuccessful.

10. The method of claim 7, wherein the generating step generates a link layer trigger to indicate if an Internet Protocol Control Protocol link is closed.

11. The method of claim 7, wherein the generating step generates a link layer trigger to indicate if an Internet Protocol Control Protocol link is being closed because of a time out event.

12. The method of claim 1, wherein the generating step generates a trigger to indicate if a lower layer link failure has taken place with respect to the link.

13. The method of claim 1, wherein the generating step generates a trigger to indicate if link quality of the link is below a threshold.

14. The method of claim 1, wherein the generating step generates a trigger to indicate if the link will be terminated because of a time-out event.

15. The method of claim 1, wherein the generating step generates a trigger to indicate that a local end-point is closing the link.

16. The method of claim 1, wherein the generating step generates a trigger to indicate that a remote end-point is closing the link.

17. The method of claim 1, wherein the generating step is performed by running a state machine at the point-to-point protocol layer.
